(19) United States
(12) Patent Application Publication
(10) Pub. No.: US 2022/0399005 A1
(43) Pub. Date: Dec. 15, 2022

(54) SYSTEM FOR DECISIONING RESOURCE USAGE BASED ON REAL TIME FEEDBACK

(71) Applicant: BANK OF AMERICA CORPORATION, Charlotte, NC (US)

(72) Inventors: Joseph Benjamin Castinado, North Glenn, CO (US); Lee Ann Proud, Ponte Vedra, FL (US)

(73) Assignee: BANK OF AMERICA CORPORATION, Charlotte, NC (US)

(21) Appl. No.: 17/343,145

(22) Filed: Jun. 9, 2021

(51) Int. Cl. G10L 13/033; G06N 3/08; G06F 16/635; G06F 16/638

(52) U.S. Cl. CPC G10L 13/033; G06N 3/08; G06F 16/635; G06F 16/638

(57) ABSTRACT

Embodiments of the invention are directed to systems, methods, and computer program products for advising users on resource decisioning based on real-time user feedback. The invention utilized advanced machine learning technology in order emulate the voice patterns of familiar figures and generate text-to-speech audio files containing relevant recommendations to one or more users as determined by their user resource account history or indicated preferences. The invention may further account for the user's response in resource usage patterns after the recommendation is provided via continuous monitoring of the user's resource usage history, and may use this data to adapt over time to learn which voices or emulations the user prefers.

### BACKGROUND

In the context of resource efficiency, savings, and usage, users will often look to trusted sources for advice on managing resources. This is particularly important for users with relatively little experience in building resource accounts and maintaining a history of responsible resource usage. Additionally, users may have a tendency to put increased trust in or weight on the opinions of those that they respect, admire, or simply recognize. As such, it is beneficial to build a system which can produce advice relevant to responsible resource usage with the added flexibility of emulating the voice or character of a wide range of well known individuals.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The systems and methods described herein address the above needs by providing intelligent system and methods for advising users on resource decisioning based on real-time user feedback. The system is adaptive, in that it can be adjusted based on the needs or goals of the user utilizing it, or may intelligently and proactively adapt based on a user's resource transaction history, resource account history, interests of the user, or the like. The system may be seamlessly embedded within existing applications or programs that the user may already use to interact with one or more entities, particularly those which aid in the managing of user resources. For instance, the system may be adjusted to analyze transactions, deposits, withdrawals, or the like, associated with a user's resource account to determine particular interests of the user, spending habits of the user, savings goals of the user, payment obligations of the user, or the like. The system may utilize this information in order to intelligently generate advice for the user regarding their resource usage. Tailored advice may include recommendations for setting resources aside on a periodic basis to meet a certain goal, putting resources toward a particular obligation to reduce overall financing costs, or the like. In addition, advice may be tailored to the overall experience level of a user based on their account history, submitted user information, or the like (e.g., a user which has recently established their first resource account may be interested in different advice or tips versus a user which has many resource accounts or a long history of resource usage with many entities).

In addition to offering advice tailored to one or more users' particular interests or needs, the system may also dynamically customize the delivery of this information in order to intelligently appeal to the user and increase the odds that the user will take the advice seriously or consider it to be trustworthy. For instance, various methods of emulating voice patterns may be employed by the invention in order to generate text-to-speech communications for the user in a voice that the user would recognize as a well-known, trusted, revered, famous, or otherwise interesting individual. The system may account for the user's response in resource usage patterns after the advice is transmitted to the user by continuous monitoring of the user's resource usage history, or the like, and adapt over time to learn which voices or emulations the user prefers. In other embodiments, the user may be presented with a selection of one or more individuals which they would prefer to hear from, and the system may adapt the user's suggestions or preferences accordingly.

Embodiments of the invention relate to systems, methods, and computer program products for dynamic feedback on resource usage, the system generally comprising the following steps: receive user resource account data for a user resource account; based on the user resource account data, generate one or more recommendations; retrieve a voice print model for a voice print source; input the one or more recommendations in a text format to the voice print model and generate an audio file of the one or more recommendations; and transmit the audio file to a user device associated with the user resource account.

In some embodiments, the user resource account data further comprises resource outflow history, resource inflow history, one or more purchased products or services, one or more locations, or one or more user characteristics associated with the user resource account.

In some embodiments, the one or more recommendations further comprise suggestions for altering resource usage habits of a user.

In some embodiments, the invention is further configured to select the voice print source based on one or more user characteristics identified from the user resource account data.

In some embodiments, the invention is further configured to generate the voice print model via receiving one or more audio samples for the voice print source; and processing the one or more audio samples via recurrent neural network.

In some embodiments, the audio file of the one or more recommendations further comprises an audio clip emulating the voice of the voice print source.

In some embodiments, the invention is further configured to: continuously monitor additional user resource account data for the user resource account; identify a change in resource usage patterns following transmission of the audio file to the user device associated with the user resource account; and generate an inference that the voice print source is preferred by a user associated with the user resource account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the intelligent feedback system, in accordance with one embodiment of the present disclosure;

FIG. 2 is a block diagram illustrating components of the intelligent feedback system, in accordance with one embodiment of the present disclosure;

FIG. 3 is a block diagram illustrating a user device associated with the intelligent feedback system, in accordance with one embodiment of the present disclosure;

FIG. 4 is a flow diagram illustrating a process of generating voice print models, in accordance with one embodiment of the present disclosure; and

FIG. 5 is a flow diagram illustrating a process for generating a tailored voice response, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. Accordingly, as used herein the term “user device” or “mobile device” may refer to mobile phones, personal computing devices, tablet computers, wearable devices, and/or any portable electronic device capable of receiving and/or storing data therein and are owned, operated, or managed by a user.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

The system allows for use of a machine learning engine to intelligently identify patterns in received resource transaction data as potentially malfeasant. The machine learning engine may be used to analyze historical data in comparison to real-time received transaction data in order to identify malfeasant transactions. The machine learning engine may also be used to generate intelligent aggregation of similar data based on metadata comparison resource transaction characteristics, which in some cases may be used to generate a database visualization of identified patterns similarities.

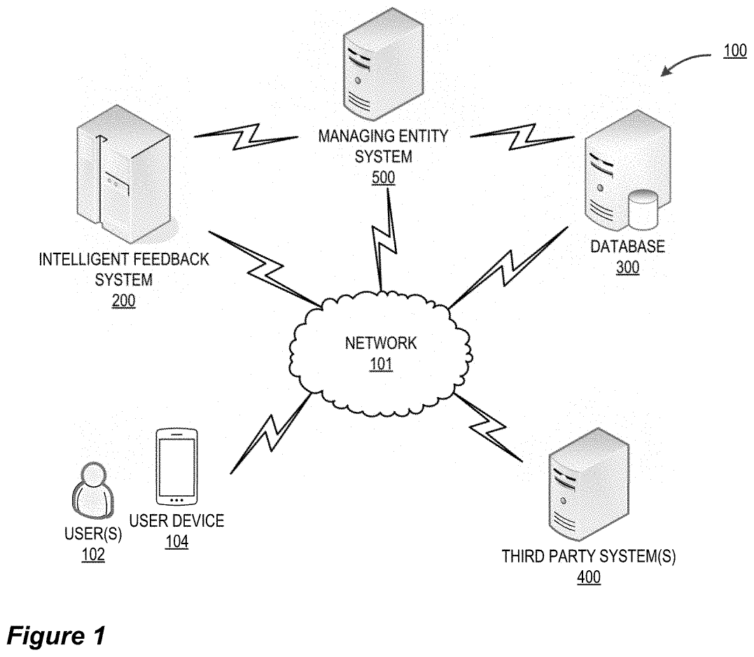

FIG. 1 illustrates an operating environment for decisioning resource usage based on real time feedback, in accordance with one embodiment of the present disclosure. As illustrated, the operating environment 100 may comprise a user 102 and/or a user device 104 in operative communication with one or more third party systems 400 (e.g., web site hosts, registry systems, financial entities, third party entity systems, or the like). The operative communication may occur via a network 101 as depicted, or the user 102 may be physically present at a location separate from the various systems described, utilizing the systems remotely. The operating environment also includes a managing entity system 500, intelligent feedback system 200, a database 300, and/or other systems/devices not illustrated herein and connected via a network 101. As such, the user 102 may request information from or utilize the services of the intelligent feedback system 200, or the third party system 400 by establishing operative communication channels between the user device 104, the managing entity system 500, and the third party system 400 via a network 101.

Typically, the intelligent feedback system 200 and the database 300 are in operative communication with the managing entity system 500, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the third party system 400). In this regard, the wireless communication channel may further comprise near field communication (NFC), communication via radio waves, communication through the internet, communication via electromagnetic waves and the like.

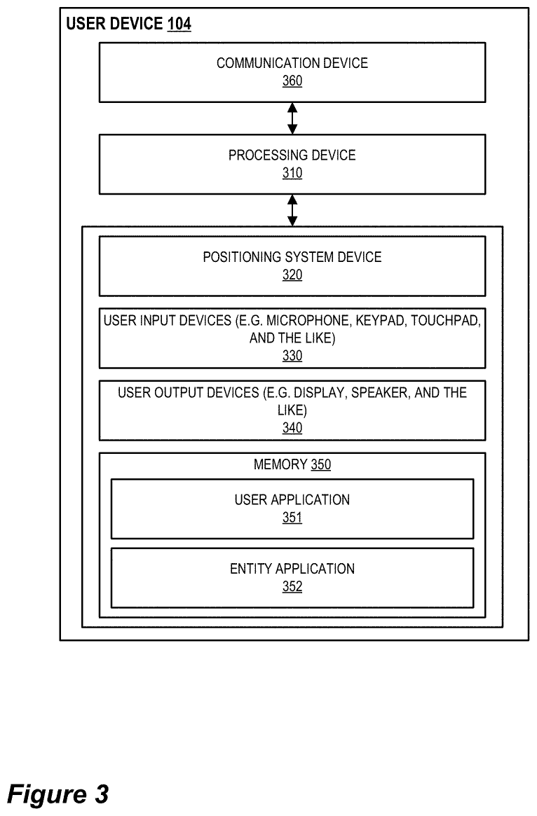

The user device 104 may comprise a mobile communication device, such as a cellular telecommunications device (e.g., a smart phone or mobile phone, or the like), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. The user device is described in greater detail with respect to FIG. 3.

The managing entity system 500 may comprise a communication module and memory not illustrated, and may be configured to establish operative communication channels with a third party system 400 and/or a user device 104 via a network 101. The managing entity may comprise a data repository 256. The data repository 256 may contain resource account data, and may also contain user data. This user data may be used by the managing entity to authorize or validate the identity of the user 102 for accessing the system (e.g., via a username, password, biometric security mechanism, two-factor authentication mechanism, or the like). In some embodiments, the managing entity system is in operative communication with the intelligent feedback system 200 and database 300 via a private communication channel. The private communication channel may be via a network 101 or the intelligent feedback system 200 and database 300 may be fully integrated within the managing entity system 500, such as a virtual private network (VPN), or over a secure socket layer (SSL).

The managing entity system 500 may communicate with the intelligent feedback system 200 in order to transmit data associated with observed resource transaction or account data by or via a plurality of third party systems 400. In some embodiments, the managing entity may utilize the features and functions of the intelligent feedback system 200 to initialize advisory measures in response to identifying user interests or needs. In other embodiments, the managing entity and/or the one or more third party systems may utilize the intelligent information sharing system to react to identified trends in user resource account history or identified user interests.

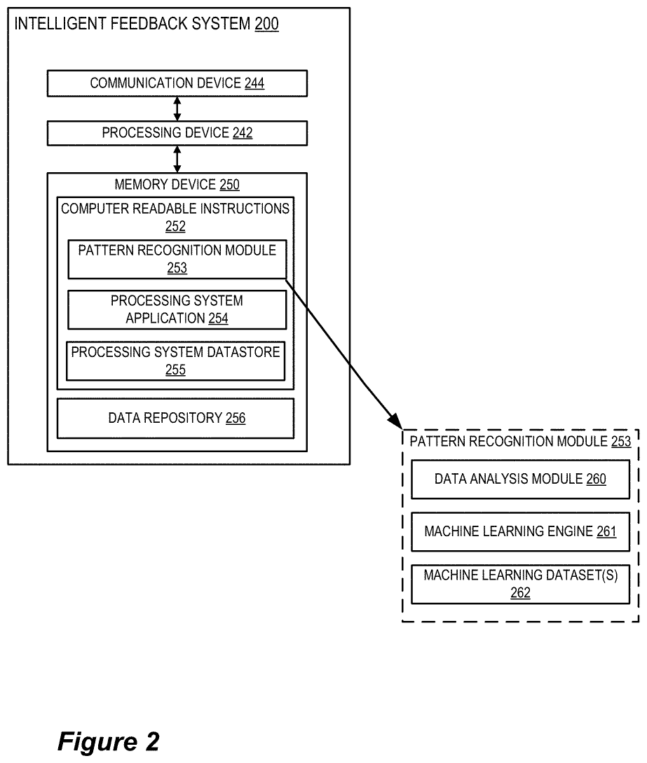

FIG. 2 illustrates a block diagram of the intelligent feedback system 200 associated with the operating environment 100, in accordance with embodiments of the present invention. As illustrated in FIG. 2, the intelligent feedback system 200 may include a communication device 244, a processing device 242, and a memory device 250 having a pattern recognition module 253, a processing system application 254 and a processing system datastore 255 stored therein. As shown, the processing device 242 is operatively connected to and is configured to control and cause the communication device 244, and the memory device 250 to perform one or more functions. In some embodiments, the pattern recognition module 253 and/or the processing system application 254 comprises computer readable instructions that when executed by the processing device 242 cause the processing device 242 to perform one or more functions and/or transmit control instructions to the database 300, the managing entity system 500, or the communication device 244. It will be understood that the pattern recognition module 253 or the processing system application 254 may be executable to initiate, perform, complete, and/or facilitate one or more portions of any embodiments described and/or contemplated herein. The pattern recognition module 253 may comprise executable instructions associated with data processing and analysis and may be embodied within the processing system application 254 in some instances. The intelligent feedback system 200 may be owned by, operated by and/or affiliated with the same managing entity that owns or operates the managing entity system 500. In some embodiments, the intelligent feedback system 200 is fully integrated within the managing entity system 500.

The pattern recognition module 253 may further comprise a data analysis module 260, a machine learning engine 261, and a machine learning dataset(s) 262. The data analysis module 260 may store instructions and/or data that may cause or enable the intelligent feedback system 200 to receive, store, and/or analyze data received by the managing entity system 500 or the database 300, as well as generate information and transmit responsive data to the managing entity system 500 in response to one or more requests or via a real-time data stream between the intelligent feedback system 200 and the managing entity system 500. The data analysis module may process data to identify relevant data to be fed to the machine learning engine 261. For instance, in some embodiments, the data analysis module may receive a number of audio data files containing metadata which identifies the files as originating from a specific source or containing the voice of a specific person, or the like, and may package this data to be analyzed by the machine learning engine 261, as well as store the files in a catalog of data files in the data repository 256 or database 300 (e.g., files may be catalogued according to any metadata characteristic, including descriptive characteristics such as source, identity of speaker in voice sample, or the like, or including data characteristics such as file type, size, sample rate, frequency patterns, length, or the like). The machine learning engine 261 and machine learning dataset(s) 262 may store instructions and/or data that cause or enable the intelligent feedback system 200 to generate, in real-time and based on received information, new audio files which emulate the voice pattern and frequency characteristics of one or more voice samples provided via the data analysis module 260, and which include speech according to whatever text is either input or intelligently generated by the system. In some embodiments, the machine learning engine 261 and machine learning dataset(s) 262 may store instructions and/or data that cause or enable the intelligent feedback system 200 to determine, in real-time and based on received information, a recommended resource actions to be taken to benefit one or more specific users based on their interests, goals, or resource account history, or the like, and text-based recommendations based on the recommended resource actions.

The machine learning dataset(s) 262 may contain data queried from database 300 or may be extracted or received from third party systems 400, managing entity system 500, or the like, via network 101. The database 300 may also contain metadata related to transactions (e.g., account, time, associated parties, merchants, products, data format, resource value, or the like). In some embodiments, the machine learning dataset(s) 262 may also contain data relating to user activity or device information, which may be stored in a user account managed by the managing entity system. In other embodiments, the database 300 may contain a catalog of voice samples of known users, public figures, or the like, and may also contain system-generated machine learning output which allows the system to quickly access the voice pattern generation characteristics required to generate new audio files without the need for emulating a particular voice for which the system has already generated requisite data (or “learned” data). In some embodiments, the machine learning engine 261 may be a single-layer recurrent neural network (RNN) for audio generation which utilizes sequential models to achieve results in audio and textual domains. In some embodiments the machine learning engine 261 is a single-layer RNN with a dual softmax layer that is designed to efficiently predict 16-bit raw audio samples. RNN methods and systems are known in the art which can produce high-fidelity audio samples based on limited input in real-time or faster-than-real-time using a graphical processing unit (GPU) or central processing unit (CPU) (e.g., WaveRNN, WaveNET, or the like). One of ordinary skill in the art will appreciate that the use of these or other like-algorithms can enable the machine learning engine 261 to receive audio samples, perform efficient analysis of the audio samples, and generate new audio samples in a text-to-speech process to emulate one or more human voice characteristics of the speaker in the original audio sample.

Additionally, the machine learning engine 261 may serve an alternate or dual purpose of analyzing user resource account history, user preferences, user interests, or other user submitted or gathered data from managing entity system 500, third party system 400, or the like, in order to generate or locate intelligent recommendations tailored to the specific user. For instance, the machine learning engine may consist of a multilayer perceptron neural network, recurrent neural network, or a modular neural network designed to process input variables related to one or more user characteristics and output recommendations or predictions relevant to the user. Given the nature of the managing entity system 500, particularly in embodiments where the managing entity system 500 is a financial institution, the machine learning engine 261 may have a large dataset of user account information, resource transaction information, account resource amount information, or the like, from which to draw from and discern specific patterns or correlations related to resource spending, saving, or the like which may be beneficial or of interest to particular users. It is understood that such data may be anonymized or completely stripped of identifying characteristics in preferred embodiments with no negative impact the system's ability to generate accurate output or prediction data given certain variables. For instance, users with a resource deposit amount of X, and a resource outflow amount of Y, and whose transaction histories indicate an interest in product category Z, may be interested in a particular product, service, or the like offered by the managing entity system 500 (e.g., a user who has a certain amount of disposable resources who is known to have purchased home-improvement products in the preceding weeks or months may be interested in a specialized line of home equity credit, an additional specialized savings account, or the like).

These intelligently generated recommendations may be related to products or services offered by one or more entities, while in other embodiments may be generally directed to beneficial tips or advice on increasing resource savings, resource inflow, or the like (e.g., a user which has a newly established resource savings account may be interested in saving a certain percentage of resource inflow per month, as recognized and recommended by the machine learning engine 261). In this way, the system may analyze user activity and resources on a per-user basis, accurately forecast beneficial suggestions or recommendations relevant to the user based on a larger dataset of numerous users, and automatically generate tailored recommendations for specific users. Recommendations or advice may also be generated in response to an explicit question received from one or more users in real-time. For instance, a sequence-to-sequence machine learning engine 261 may consist of two recurrent neural networks designed to process text-based questions and produce intelligent output in response by identifying relevant information based on the variables presented by the user. For instance, a user may indicate an interest in increasing their resource savings, and the system may respond with a breakdown of the user's resource outflow delineated by product or service categories. If resource outflow in a particular category is relatively higher than average, or relatively higher than that of other categories, the system may intelligently generate a recommendation to reduce resource outflow in that particular category. As opposed to transmitting the recommendation in a text-based format, the system may utilize a text-to-speech dataset in a specific voice pattern in order to communicate with the user in the voice which emulates a specific person, or the like.

The machine learning engine 261 may receive data from a plurality of sources and, using one or more machine learning algorithms, may generate one or more machine learning datasets 262. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention.

The communication device 244 may generally include a modem, server, transceiver, and/or other devices for communicating with other devices on the network 101. The communication device 244 may be a communication interface having one or more communication devices configured to communicate with one or more other devices on the network 101, such as the intelligent feedback system 200, the user device 104, other processing systems, data systems, etc.

Additionally, referring to intelligent feedback system 200 illustrated in FIG. 2, the processing device 242 may generally refer to a device or combination of devices having circuitry used for implementing the communication and/or logic functions of the intelligent feedback system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the intelligent feedback system 200 may be allocated between these processing devices according to their respective capabilities. The processing device 242 may further include functionality to operate one or more software programs based on computer-executable program code 252 thereof, which may be stored in a memory device 250, such as the processing system application 254 and the pattern recognition module 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the intelligent feedback system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

FIG. 3 is a block diagram illustrating a user device associated with the intelligent feedback system, in accordance with one embodiment of the present disclosure. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, gaming devices, laptop computers, cameras, video recorders, audio/video player, radio, GPS devices, any combination of the aforementioned devices.

The user device 104 may generally include a processing device or processor 310 communicably coupled to devices such as, a memory device 350, user output devices 340 (for example, a user display or a speaker), user input devices 330 (such as a microphone, keypad, touchpad, touch screen, and the like), a communication device or network interface device 360, a positioning system device 320, such as a geo-positioning system device like a GPS device, an accelerometer, and the like, one or more chips, and the like.

The processor 310 may include functionality to operate one or more software programs or applications, which may be stored in the memory device 350. For example, the processor 310 may be capable of operating applications such as a user application 351, an entity application 352, or a web browser application. The user application 351 or the entity application may then allow the user device 104 to transmit and receive data and instructions to or from the third party system 400, intelligent feedback system 200, and the managing entity system 500, and display received information via the user interface of the user device 104. The user application 351 may further allow the user device 104 to transmit and receive data to or from the managing entity system 500 (for example, via wireless communication or NFC channels), data and instructions to or from the intelligent feedback system 200, web content, such as, for example, location-based content and/or other web page content, according to a Wireless Application Protocol (WAP), Hypertext Transfer Protocol (HTTP), and/or the like. The user application 351 may allow the managing entity system 500 to present the user 102 with a plurality of recommendations, identified trends, suggestions, transaction data, pattern data, graph data, statistics, and/or the like for the user to review. In some embodiments, the user interface displayed via the user application 351 or entity application 352 may be entity specific. For instance, while the intelligent feedback system 200 may be accessed by multiple different entities, it may be configured to present information according to the preferences or overall common themes or branding of each entity system of third party system. In this way, each system accessing the intelligent feedback system 200 may use a unique entity application 352 or user application 351 portal while all entities may access the same information, given that they are permitted by the managing entity system 500.

The processor 310 may be configured to use the communication device 360 to communicate with one or more devices on a network 101 such as, but not limited to the third party system 400, the intelligent feedback system 200, and the managing entity system 500. In this regard the processor 310 may be configured to provide signals to and receive signals from the communication device 360. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols and/or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance Bluetooth® low energy, audio frequency, ultrasound frequency, or other communication/data networks.

The communication device 360 may also include a user activity interface presented in user output devices 340 in order to allow a user 102 to execute some or all of the processes described herein. The application interface may have the ability to connect to and communicate with an external data storage on a separate system within the network 101. The user output devices 340 may include a display (e.g., a liquid crystal display (LCD) or the like) and a speaker or other audio device, which are operatively coupled to the processor 310 and allow the user device to output generated audio received from the intelligent feedback system 200. The user input devices 330, which may allow the user device 104 to receive data from the user 102, may include any of a number of devices allowing the user device 104 to receive data from a user 102, such as a keypad, keyboard, touch-screen, touchpad, microphone, mouse, joystick, other pointer device, button, soft key, and/or other input device(s).

The user device 104 may also include a memory buffer, cache memory or temporary memory device 350 operatively coupled to the processor 310. Typically, one or more applications 351 and 352, are loaded into the temporarily memory during use. As used herein, memory may include any computer readable medium configured to store data, code, or other information. The memory device 350 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the intelligent feedback system 200 performing one or more steps described herein in conjunction with other devices and systems, either automatically based on executing computer readable instructions of the memory device 250, or in response to receiving control instructions from the managing entity system 500. In some instances, the system refers to the devices and systems on the operating environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

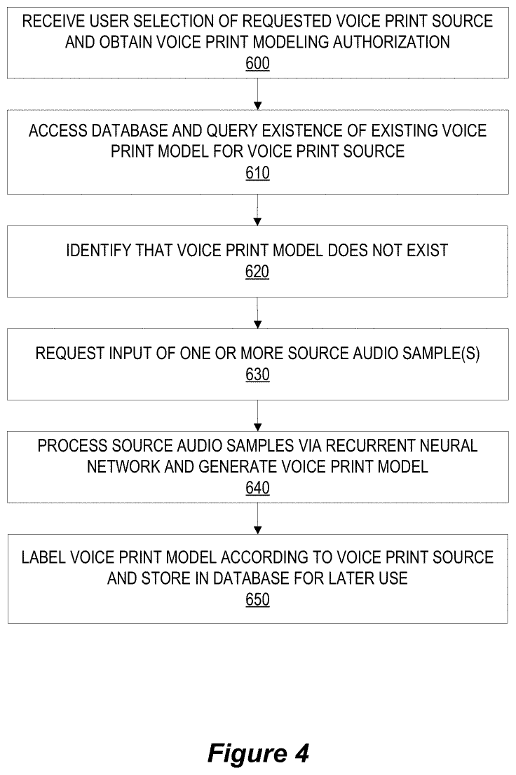

FIG. 4 is a flow diagram illustrating a process of generating voice print models, in accordance with one embodiment of the present disclosure. As shown in block 600, the process begins whereby the intelligent feedback system 200 receives a user selection or request for a voice print source. In some embodiments, the user in this instance may be a system administrator or system engineer which is populating the intelligent feedback system 200 with voice print models for emulating the voices of various people or figures, or “voice print sources.” In other embodiments, the user may be a customer of the managing entity system whom is selecting one or more particular voice print models from a pre-existing list of developed voice print models, while in other embodiments, the user may request a new voice print model creation. In any instance, the intelligent feedback system 200 requires authorization from the person or figure for which the voice print model will be emulating. For instance, if “celebrity X” is to be emulated, the intelligent feedback system 200 may first require a release, license, contract, smart contract, certificate, or the like to indicate that celebrity X approves of their voice to be emulated and used for the specific purposes of the intelligent feedback system 200 (e.g., the intelligent feedback system 200 may generate a smart contract or the like for digital signature or authorization from the subject to be emulated, may require a document to be uploaded or recognized as being on file, may require verification from a compliance department of the managing entity system, or the like).

Next, as shown in block 610, the intelligent feedback system 200 may access the database 300 or other datastore, such as data repository 256, in order to query existence of existing voice print model to use for the voice print source. For instance, in some embodiments where a user or customer selects a voice print source, the voice print model for the particular voice print model may already have been generated and stored by the intelligent feedback system 200. If the voice print model does not exist, as shown in block 620, the process proceeds to block 630, wherein the intelligent feedback system 200 requests input of one or more source audio sample(s). As discussed with respect to FIG. 2, the audio sample is then processed via the RNN model of the machine learning engine 261 in order to generate a voice print model based on the source audio samples. The sample is then labeled according to the particular voice print source and stored in the database 300, data repository 256, or the like for later reference in generating tailored audio responses.

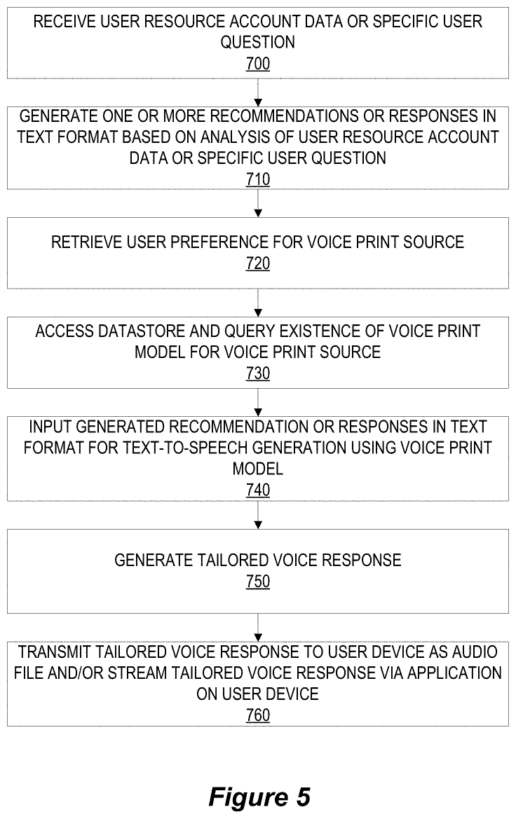

FIG. 5 is a flow diagram illustrating a process for generating a tailored voice response, in accordance with one embodiment of the present disclosure. As shown in block 700, the process begins wherein the intelligent feedback system 200 specific data on which to generate a recommendation, such as user resource account data or a specific user question. In some embodiments, the intelligent feedback system 200 may infer from the user resource account data that the user may be interested in or benefit from certain recommendations. For instance, user resource account data may indicate one or more products that the user typically purchases and may want to set money aside to save for. In other embodiments, the user resource account data may indicate that the user's spending habits are relatively high or low in a specific category as compared to other similar users (e.g., users of the same region, users with the same general monthly resource inflow from their employer, or the like), as may generate a recommendation to alter spending patterns in some way (e.g., a suggestion of cutting back on dining out, transferring resources to savings, spending less on clothing, or the like). In this way, the system may generate one or more recommendations or responses in a text format based on analysis of the user resource account data, or in response to a specific user question (e.g., the system may recognize that the user is inquiring about setting up a new savings account, or the like, and respond with next steps), as indicated by block 710.

Next, as shown in block 720, the intelligent feedback system 200 retrieves user preference for voice print source. In some embodiments, the user may set a preference for one or more voice print sources, such as via the entity application 352 or user application 351 on the user device 104. In other embodiments, the system may infer from the user resource account data that the user has a particular interest in a certain type of music, clothing, entertainment, restaurant, city, or the like, and may intelligently select a voice print source related to one or more categories the user's resource history indicates would be relevant or of interest to the user. For instance, the intelligent feedback system 200 may analyze the user's resource account data and determine that the user dined at a restaurant owned by a specific celebrity chef, and may select the celebrity chef as the voice print source. In other embodiments, the intelligent feedback system 200 may determine that the user attended a sporting event in a particular city, and may select a star athlete as the voice print source. The intelligent feedback system 200 then accesses the database 300 and queries if the voice print model exists or is available or the voice print source, as shown in block 730, and retrieves available and relevant voice print models. The system may then use one or more retrieved voice print models and input the generated text-based recommendation or response for text-to-speech generation using the voice print model as a template for the RNN of the machine learning engine 261. Finally, the system generates a tailored voice response, as shown in block 750, and may transmit the tailored voice response to the user device 104 as an audio file, or stream the tailored voice response via the entity application 351 or user application 352 via the user device 104.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic feedback on resource usage, the system comprising:
at least one non-transitory storage device; and
at least one processing device coupled to the at least one non-transitory storage device, wherein the at least one processing device is configured to:
receive user resource account data for a user resource account;
based on the user resource account data, generate one or more recommendations;
retrieve a voice print model for a voice print source;
input the one or more recommendations in a text format to the voice print model and generate an audio file of the one or more recommendations; and
transmit the audio file to a user device associated with the user resource account.

2. The system of claim 1, wherein the user resource account data further comprises resource outflow history, resource inflow history, one or more purchased products or services, one or more locations, or one or more user characteristics associated with the user resource account.

3. The system of claim 1, wherein the one or more recommendations further comprise suggestions for altering resource usage habits of a user.

4. The system of claim 1, further configured to select the voice print source based on one or more user characteristics identified from the user resource account data.

5. The system of claim 1, further configured to generate the voice print model via:
receiving one or more audio samples for the voice print source; and
processing the one or more audio samples via recurrent neural network.

6. The system of claim 1, wherein the audio file of the one or more recommendations further comprises an audio clip emulating a voice pattern of the voice print source.

7. The system of claim 1, further configured to:
continuously monitor additional user resource account data for the user resource account;
identify a change in resource usage patterns following transmission of the audio file to the user device associated with the user resource account; and
generate an inference that the voice print source is preferred by a user associated with the user resource account.

8. A computer program product for dynamic feedback on resource usage, the computer program product comprising at least one non-transitory computer-readable medium having computer-readable program code portions embodied therein, the computer-readable program code portions comprising:
an executable portion configured to receive user resource account data for a user resource account;
an executable portion configured to, based on the user resource account data, generate one or more recommendations;
an executable portion configured to retrieve a voice print model for a voice print source;
an executable portion configured to input the one or more recommendations in a text format to the voice print model and generate an audio file of the one or more recommendations; and
an executable portion configured to transmit the audio file to a user device associated with the user resource account.

9. The computer program product of claim 8, wherein the user resource account data further comprises resource outflow history, resource inflow history, one or more purchased products or services, one or more locations, or one or more user characteristics associated with the user resource account.

10. The computer program product of claim 8, wherein the one or more recommendations further comprise suggestions for altering resource usage habits of a user.

11. The computer program product of claim 8, further configured to select the voice print source based on one or more user characteristics identified from the user resource account data.

12. The computer program product of claim 8, further configured to generate the voice print model via:
receiving one or more audio samples for the voice print source; and
processing the one or more audio samples via recurrent neural network.

13. The computer program product of claim 8, wherein the audio file of the one or more recommendations further comprises an audio clip emulating a voice pattern of the voice print source.

14. The computer program product of claim 8, further configured to:
continuously monitor additional user resource account data for the user resource account;
identify a change in resource usage patterns following transmission of the audio file to the user device associated with the user resource account; and
generate an inference that the voice print source is preferred by a user associated with the user resource account.

15. A computer-implemented method for dynamic feedback on resource usage, the method comprising:
providing a computing system comprising a computer processing device and a non-transitory computer readable medium, wherein the computer readable medium comprises configured computer program instruction code, such that when said instruction code is operated by said computer processing device, said computer processing device performs the following operations:
receive user resource account data for a user resource account;
based on the user resource account data, generate one or more recommendations;
retrieve a voice print model for a voice print source;
input the one or more recommendations in a text format to the voice print model and generate an audio file of the one or more recommendations; and
transmit the audio file to a user device associated with the user resource account.

16. The computer-implemented method of claim 15, wherein the user resource account data further comprises resource outflow history, resource inflow history, one or more purchased products or services, one or more locations, or one or more user characteristics associated with the user resource account.

17. The computer-implemented method of claim 15, wherein the one or more recommendations further comprise suggestions for altering resource usage habits of a user.

18. The computer-implemented method of claim 15, further configured to select the voice print source based on one or more user characteristics identified from the user resource account data.

19. The computer-implemented method of claim 15, further configured to generate the voice print model via:
receiving one or more audio samples for the voice print source; and
processing the one or more audio samples via recurrent neural network.

20. The computer-implemented method of claim 15, wherein the audio file of the one or more recommendations further comprises an audio clip emulating a voice pattern of the voice print source.
